(19) United States
(12) Patent Application Publication
(10) Pub. No.: US 2019/0229546 A1
(43) Pub. Date: Jul. 25, 2019

(54) Power Supply System

(71) Applicant: XelectriX Power GmbH, Mauthausen (AT)

(72) Inventor: Alexander Hartl, Leonding (AT)

(21) Appl. No.: 16/257,588

(22) Filed: Jan. 25, 2019

(30) Foreign Application Priority Data
Jan. 25, 2018 (EP) 18450001.5

(51) Int. Cl. H02J 7/00; H02J 3/00; H02M 1/10

(52) U.S. Cl. CPC H02J 7/0065; H02M 1/10; H02J 3/005; H02J 7/007

(57) ABSTRACT

A power supply system includes an input terminal that receives electrical energy from an alternating current source and an output terminal connected to a load. Current and voltage measuring devices measure current and voltage values of the electrical energy received from the alternating current source. Three phase conductors and a neutral conductor connect the input terminal to the output terminal. A power converter includes a direct current terminal and an alternating current terminal that is coupled to the load. The power converter outputs alternating voltage. A DC link connects the direct current terminal to a chargeable electrical energy storage system. A control unit controls the alternating voltage output by the power converter onto the alternating current terminal, which is connected to the phase conductors in parallel with the alternating current source. The control unit uses the current and voltage values to control the alternating voltage output by the power converter.

### CROSS REFERENCE TO RELATED APPLICATION

This application is based on and hereby claims the benefit under 35 U.S.C. § 119 from European Patent Application No. EP 18450001.5, filed on Jan. 25, 2018, in the European Patent Office. This application is a continuation-in-part of European Patent Application No. EP 18450001.5, the contents of which are incorporated herein by reference.

### TECHNICAL FIELD

The invention relates to a power supply system that permits power to be provided both from a power supply grid of alternating current and as direct current from an energy storage system.

### BACKGROUND

Conventional power supply systems are known that are used in areas in which a power supply from the public power grid is not available, for example, at construction sites, in remote areas, or when the power grid has failed. Such power supply systems supply various devices with power autonomously or independently of the power grid. Such power supply systems have essentially a generator that is driven by an internal combustion engine, in particular, a gasoline engine or diesel engine. The devices to be operated may be connected to the generator and are thereby operated.

Other power supply systems are known in which the generator is connected to a circuit through a rectifier, such as a direct current (DC) link. Such systems supply an electrical energy storage system with power through the rectifier. It is thus possible to operate the generator at the optimal operating point. In addition, it is known how to connect the DC link of such power supply systems to power generators, such as photovoltaic systems or wind turbines, or to use such power generators instead of the power supply system.

A disadvantage of such power supply systems is the limitation of the maximum load based on the capacity of the energy storage system or battery. The electrical energy storage system must therefore be designed with relatively large dimensions. Power supply systems are thus known that additionally use an energy supply network when available. The energy supply system is then connected to the optionally present energy supply network in order to allow charging of the electrical energy storage system on the energy supply network on the one hand, and on the other hand to operate the electrical load directly from the energy supply network. As stated at the outset, such power supply systems include an input terminal from an alternating current source such as the energy supply network, an output terminal for connecting an electrical load, power supply lines that connect the input terminal to the output terminal, including at least one phase conductor and one neutral conductor, and at least one power converter having a direct current terminal and an alternating current terminal. The alternating current terminal is connected to the electrical load and a DC link, to which at least one chargeable electrical energy storage system is connected through the direct current terminal. A control device is provided for controlling the alternating voltage that is supplied by the power converter via the alternating current terminal.

However, a disadvantage with such power supply devices is that the electrical load can make use of only a single power source, i.e., by being fed either by the power supply grid or by the power converter of the power supply system, so that a combined operation is not possible. In addition, with conventional systems it is not readily possible to feed excess energy that may be locally available, for example the energy provided by a photovoltaic system, into the power supply grid.

An object of the present invention is, therefore, to design a power supply system in such a way that there is the greatest possible flexibility in the selection of the supply source, and possible excess energy may be fed into the supply network so that a number of different operating modes can be implemented.

### SUMMARY

The invention relates to a power supply system comprising an input terminal for an alternating current source, an output terminal for connecting an electrical load, power supply lines that connect the input terminal to the output terminal, comprising at least one phase conductor and one neutral conductor, and at least one power converter having a direct current terminal and an alternating current terminal, wherein the alternating current terminal is connectable to the electrical load, and a DC link to which at least one chargeable electrical energy storage system is connected to the direct current terminal, and wherein a control device is provided for controlling the alternating voltage that is suppliable by the power converter via the alternating current terminal.

A power supply system includes an input terminal that receives electrical energy from an alternating current source and an output terminal connected to a load. A current measuring device measures current values of the electrical energy received from the alternating current source, and a voltage measuring device measures voltage values of the electrical energy received from the alternating current source. Three phase conductors and a neutral conductor connect the input terminal to the output terminal. A power converter includes a direct current terminal and an alternating current terminal that is coupled to the load. The power converter outputs an alternating voltage. A DC link connects the direct current terminal to a chargeable electrical energy storage system. A control unit controls the alternating voltage output by the power converter onto the alternating current terminal, which is connected to the phase conductors in parallel with the alternating current source. The control unit uses the current values and the voltage values to control the alternating voltage output by the power converter.

In a power supply system comprising an input terminal for an alternating current source, an output terminal for connecting an electrical load, power supply lines that connect the input terminal to the output terminal, comprising at least one phase conductor and one neutral conductor, and at least one power converter having a direct current terminal and an alternating current terminal, wherein the alternating current terminal is connectable to the electrical load, and a DC link to which at least one chargeable electrical energy storage system is connected is connected to the direct current terminal, and wherein a control unit is provided for controlling the alternating voltage that is suppliable by the power converter via the alternating current terminal, the power converter with its alternating current terminal is connected to the power supply lines in parallel with the alternating current source, and that at least one current measuring device and at least one voltage measuring device are provided for measuring current and voltage values of the alternating current source, which are supplied to the control unit in order to control the alternating voltage supplied by the power converter as a function of the current and voltage values.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 is a circuit diagram in a first design of the power supply system according to the invention.

FIG. 2 is a circuit diagram in a second design of the power supply system according to the invention.

FIG. 3 is a circuit diagram in a third design of the power supply system according to the invention.

### DETAILED DESCRIPTION

Reference will now be made in detail to some embodiments of the invention, examples of which are illustrated in the accompanying drawings.

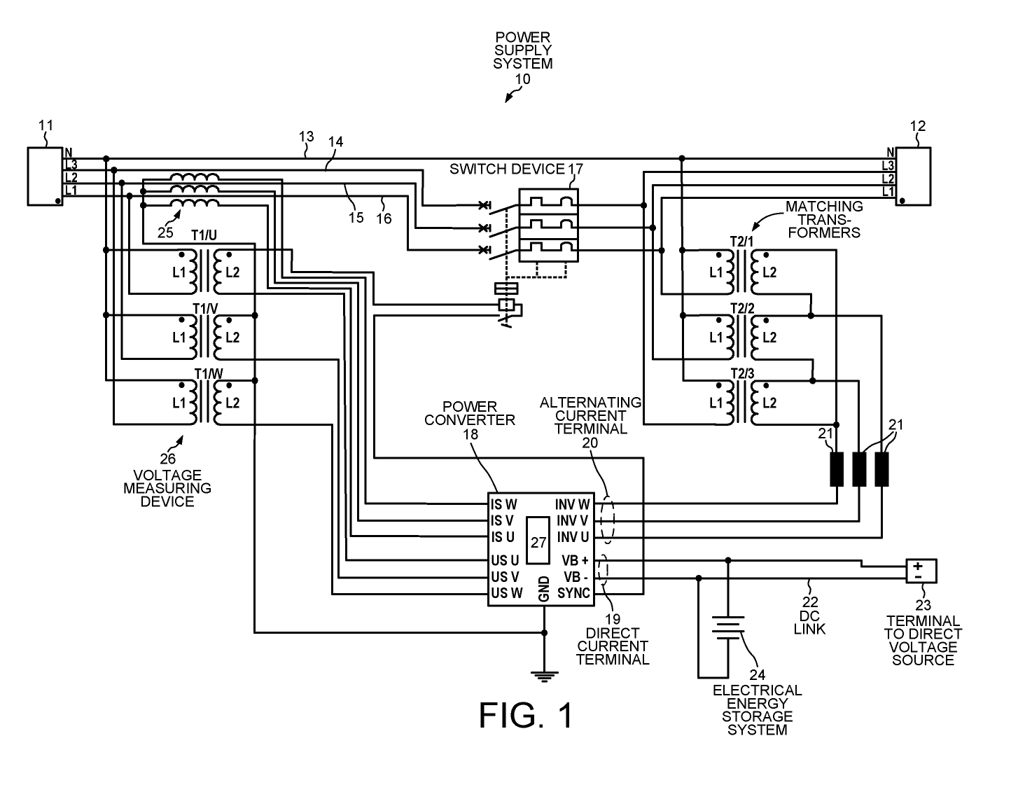

FIG. 1 is a circuit diagram of a power supply system 10 with an energy storage system 24 that permits power to be provided from both the power supply grid and from an energy storage system 24 through a power converter 18. In order to make use of the multiple power sources, the power supply system 10 connects the alternating current terminal 20 of the power converter 18 to power supply lines 13-16 in parallel with the alternating current source. At least one current measuring device 25 and at least one voltage measuring device 26 are provided for measuring current and voltage values of the alternating current source. These current and voltage values are then supplied to a control unit 27 in order to control the alternating voltage supplied by the power converter 18 as a function of the current and voltage values.

As a result of the power converter 18 with its alternating current terminal 20 being connected to the power supply lines 14-16 in parallel with the alternating current source, electrical loads are selectively supplied from the energy storage system 24, either directly or in parallel with the power supply, i.e., in addition to supplying from an alternating current source such as the power supply grid. The energy storage system 24 can be recharged as needed or to compensate for load variations. In addition, possible excess energy can be fed into the power supply network.

To enable a mode that is parallel to the power supply, the power converter 18 is preferably operated in such a way that the alternating current provided by the power converter 18 is synchronized with the alternating current of the alternating current source, such as the power supply grid. However, there is the problem that the power converter 18, due to its parallel connection, cannot detect the current parameters such as the voltage, the current amplitude, the frequency, and the phase shift, of the alternating current source. Therefore, the power supply system 10 includes at least one current measuring device 25 and at least one voltage measuring device 26 that measure current and voltage values of the alternating current source. These measured current and voltage values are then supplied to a control unit 27 in order to control the alternating voltage supplied by the power converter 18 as a function of the current and voltage values. The control preferably takes place in such a way that the alternating current provided by the power converter 18 is synchronized with the alternating current of the alternating current source with regard to voltage, current amplitude, frequency and optionally phase shift.

To enable an operating mode in which the electrical energy storage system 24 is charged, the power converter 18 is designed as a bidirectional power converter 18. The power converter 18 can thus be operated both as an inverter or as a rectifier. In the inverter mode, the direct current delivered by the DC link 22 is converted into an alternating current and is provided to the electrical load and/or is fed back into the power supply network. In the rectifier mode, the alternating current coming from the alternating current source is converted into direct current and is supplied to the electrical energy storage system 24.

To facilitate such back-charging of the electrical energy storage system 24, the voltage on the DC link 22 should be increased in comparison to the normal voltage. The DC link voltage can be increased by connecting a throttle device 21 between the alternating current terminal 20 of the power converter 18 and the alternating current source. In order to ensure a voltage supply with as little loss as possible, the DC link voltage should in any event be increased when the voltage in the electrical energy storage system 24 is above the level of the DC link voltage that is needed to supply the electrical load with alternating current. Increasing the DC link voltage results in an energy flow in the direction of the energy storage system 24.

The electrical energy storage system 24 may be implemented in various ways. Energy storage may be provided for high pendulum power and a long service life by using lithium ion (LIO) technology or supercaps. However, other battery or storage designs may be used, for example NiNaCl, NiFe, Pb, or fuel cells, and the like.

To allow operation of the power supply system 10 on a three-phase alternating current supply network, for example, the input terminal 11 is designed to connect to a three-phase alternating current source. The power supply lines 13-16 connecting the input terminal 11 to the output terminal 12 include three phase conductors 14-16 and one neutral conductor 13.

In addition, the power converter 18 is preferably designed to convert a direct current into a three-phase alternating current and/or to convert a three-phase alternating current into a direct current. The alternating current terminal 20 of the power converter 18 is designed as a three-phase alternating current terminal 20.

The alternating current terminal 20, in particular the three-phase alternating current terminal 20, is connected to the power supply lines 14-16 through at least one matching transformer T2. The matching transformer may be connected on the side of the power supply lines 14-16 by means of a star connection, and on the side of the power converter 18 by means of a delta connection.

In another embodiment, the matching transformer T2 is connected to the alternating current terminal 20 of the power converter 18 with a throttle device 21 connected in between. This allows the voltage to be increased in the DC link 22 so that the electrical energy storage system 24 can be efficiently charged.

A switch device 17 is used to selectively separate or establish a connection between the alternating current terminal 20 of the power converter 18 and the power supply lines 14-16. The switchover between various operating modes is thus easily carried out, and the power converter 18 may be switched on or off. A switch device 17 can also be used to selectively separate or establish an electrical connection between the input terminal 11 and the output terminal 12 through at least one phase conductor 14-16.

To allow automatic switching between various operating modes as a function of predefined control sequences, the switch device 17 can be switched over by the control unit 27.

To allow the connection of external direct current sources, the DC link 22 has a terminal for connecting to a direct voltage source, such as a photovoltaic system. The terminal of the DC link 22 is preferably connected to the direct voltage source by connecting a direct voltage converter in between the two.

In order to achieve various operating modes, the control unit 27 is designed to change between a first operating mode and a second operating mode of the power supply system. In the first operating mode, the electrical energy of the alternating current source is supplied through the power supply lines 13-16 to the electrical load and to the power converter 18, which is operated as a rectifier and supplies the DC link 22 with direct current and charges the electrical energy storage system 24. In the second operating mode, the electrical load is supplied with alternating current by the power converter 18 by separating the electrical connection between the input terminal 11 and the output terminal 12. The power converter 18 is operated as an inverter, and the power converter 18 is supplied with direct current from the electrical energy storage system 24 through the DC link 22. The power supply system may hereby function, for example, in a “USV mode,” as explained in greater detail below.

Additionally or alternatively, the control unit 27 is designed to change between a third and a fourth operating mode. In the third operating mode, the electrical energy of the alternating current source is supplied to the electrical load through the power supply lines 13-16, and an external direct voltage source is connected to the DC link 22 that charges the energy storage system 24. In the fourth operating mode, the external direct voltage source supplies the power converter 18 with direct current through the DC link 22. The power converter 18 is operated as an inverter and delivers an alternating current to the supply lines 14-16, which is synchronized with the alternating current source. The power supply system hereby functions, for example, in an “ON/OFF GRID mode,” as explained in greater detail below.

Additionally or alternatively, the control unit 27 is designed to change into a further operating mode in which an external direct voltage source is connected to the DC link 22, which charges the electrical energy storage system 24 and supplies direct current to the power converter 18. The power converter 18 is operated as an inverter and delivers an alternating current to the supply lines, which is synchronized with the alternating current source. The electrical load is supplied with alternating current by the power converter 18 when the electrical energy storage system 24 is charged. On the other hand, the electrical load is supplied with alternating current by the alternating current source when the electrical energy storage system 24 is discharged. The power supply system hereby functions, for example, in an “ON/OFF HYBRID mode,” as explained in greater detail below.

According to a second aspect, the invention relates to a method for supplying power using a power supply system. In a first operating mode of the system, the electrical energy of the alternating current source is supplied via power supply lines 13-16 to the electrical load and to the power converter 18. The power converter 18 is operated as a rectifier, supplies the DC link 22 with direct current, and charges the electrical energy storage system 24. In a second operating mode, the electrical load may be supplied with alternating current by the power converter 18 by separating the electrical connection between the input terminal 11 and the output terminal 12. The power converter 18 is operated as an inverter, and direct current from the electrical energy storage system 24 is supplied to the power converter 18 via the DC link 22.

Additionally or alternatively, in a third operating mode, the electrical energy of the alternating current source may be supplied to the electrical load via power supply lines 13-16. An external direct voltage source may be connected to the DC link 22, which charges the electrical energy storage system 24.

Additionally or alternatively, in a fourth operating mode, the external direct voltage source may supply the power converter 18 with direct current via the DC link 22. The power converter 18 is operated as an inverter and delivers an alternating current to the supply lines, which is synchronized with the alternating current source.

Additionally or alternatively, in a further operating mode, an external direct voltage source may be connected to the DC link 22, which charges the electrical energy storage system 24 and supplies the power converter 18 with direct current. The power converter 18 is operated as an inverter and delivers an alternating current to the supply lines, which is synchronized with the alternating current source. The electrical load is supplied with alternating current by the power converter 18, provided that the electrical energy storage system 24 is charged, whereas the electrical load is supplied with alternating current by the alternating current source, provided that the electrical energy storage system 24 is discharged.

FIG. 1 is a circuit diagram in a first design of a power supply system 10 according to the invention. Power supply system 10 includes an input terminal 11 for connecting an alternating current. The input terminal 11 is designed for connecting a three-phase alternating current source, for example a three-phase alternating current supply network, and therefore includes an electrical contact for the neutral conductor N and three electrical contacts for the phase conductors L1, L2 and L3. System 10 also includes an output terminal 12 for connecting an electrical load (not illustrated in FIG. 1) to the electrical contacts for the neutral conductor N and for the phase conductors L1, L2 and L3. Power supply lines that include one neutral conductor 13 and three phase conductors 14, 15, 16 are provided for connecting the input terminal 11 to the output terminal 12. The phase conductors 14, 15, 16 are led across a switch device 17 that can disconnect the electrical connection between the input terminal 11 and the output terminal 12. The power converter 18 has a direct current terminal 19 comprising the electrical contacts VB+ and VB−, and an alternating current terminal 20 comprising the electrical contacts INV W, INV V, and INV U. The power converter 18 with its alternating current terminal 20 is connected to the power supply lines 13, 14, 15, 16 in such a way that the alternating current terminal 20 is connected in parallel with the alternating current source when the switch device 17 is closed. The connection of the power converter 18 to power supply lines takes place via the matching transformers T2/1, T2/2, and T2/3. The matching transformers on the one hand are connected to the power converter 18 in a delta connection, and on the other hand are connected to the power supply lines 13, 14, 15, 16 in a star connection. Throttle devices 21 are situated in the connecting lines between the matching transformers T2/1, T2/2 and T2/3 and the alternating current terminal 20 of the power converter 18.

A DC link 22 that connects the power converter 18 to a direct voltage source, such as a photovoltaic system, that is connectable via the terminal 23 is connected to the direct current terminal 19 of the power converter 18. In addition, the DC link 22 has a chargeable electrical energy storage system 24.

For measuring the current flowing through the phase conductors 14, 15, 16, current measuring devices 25 in the form of coils associated with the phase conductors are provided and are connected to the measurement inputs IS W, IS V, and IS U of the power converter 18. For measuring the voltages present between the individual phase conductors 14, 15, 16 and the neutral conductor 13, a voltage measuring device 26 is provided, whose voltage tap is supplied to the measurement inputs US U, US V, and US W of the power converter 18 via the transformers T1/U, T1/V, and T1/W. The power converter 18 includes a control unit 27 for controlling the alternating voltage that is supplied by the power converter as a function of the current and voltage values.

The power supply system described in FIG. 1 allows supplying of electrical loads that are connected to the output terminal 12, in the operating modes described below.

1. Island Mode:

In the island mode, the electrical load is supplied from the energy storage system 24, which in turn may have to be supplied with energy from the outside. The direct current delivered by the energy storage system 24 is supplied to the power converter 18 via the direct current terminal 19. The alternating current generated by the power converter 18 in the inverter mode is provided to the electrical load via the power supply lines with the switch device 17 open, i.e., in a state that is disconnected from the external alternating current source. The voltage, the frequency and the phase angle of the alternating current are governed by the control unit 27, which in one embodiment is a software module. In this operating mode, the energy is conducted from the energy storage system 24 in the direction of the consumer or consumers. Parallel back-charging is not possible.

2. USV (UPS) Mode:

In the USV mode for an uninterruptible power supply (UPS), the power supply system 10 is always connected to an energy grid via the input terminal 11, and the output alternating voltage of the power converter 18 tracks the power grid voltage. The energy storage system 24 is always kept in a full state as the result of increasing the voltage on the DC link 22. If the supply voltage is lost or interrupted, the power supply system is automatically disconnected from the energy grid by means of the switch device 17 and continues to supply the consumer until the supply voltage has returned to a normal state. The supply duration is function of the size of the energy storage system 24 and the load.

3. ON/OFF GRID Mode:

In the ON/OFF GRID mode, the power supply system has two types of operation that are similar to the USV operating mode, except that the energy storage system 24 is not charged by the energy grid, but rather by some other energy source, such as a photovoltaic system that operates according to the maximum power point tracking (MPPT) technique and is connected to the terminal 23. If the energy storage system 24 is fully charged and no more energy can be stored, the excess energy is optionally transferred (or fed) into the energy grid. In the event of a power grid failure, the consumer is supplied from the energy storage system 24, the same as in the USV mode. If necessary, however, it is also always possible to charge the energy storage system 24 from the energy grid (as in the USV mode) via software or intervention on the operator side.

4. ON/OFF/HYBRID Mode:

In the ON/OFF/HYBRID mode, the operation is the same as in the ON/OFF GRID mode, except that the intent is always to cover the internal consumer load from the energy storage system 24, and to rely on the grid energy only when the energy storage system 24 is empty. This means that although the power supply system 10 is connected to the energy grid, in the normal case no energy is obtained from the energy grid if this is permitted by the state of charge of the energy storage system 24. The grid energy is relied on in parallel only when the energy in the energy storage system 24 is depleted, or more energy is requested from the system than can be delivered by the power supply system 10. However, the energy from the energy storage system 24 is always primarily preferred for supplying the consumer. The charging of the energy storage system 24 takes place in the ON/OFF/HYBRID mode the same as in the ON/OFF GRID mode, via external charging. If necessary, however, it is also always possible to charge the energy storage system from the energy grid (as in the USV mode) via software or operator intervention.

5. LOADSHAPING/ON/OFF/HYBRID Mode:

In the LOADSHAPING/ON/OFF/HYBRID mode, the power supply system 10, the same as in the other cases, is connected between the energy grid and the consumer, and as described above allows all possible operating modes. In this case, however, additional emphasis is placed on “debouncing”, i.e., very rapid adjustment of peak loads, as the result of which only limited loads (or current intensities) are obtained from the energy grid. By use of this operating mode, it is possible to supply loads in parallel from the energy grid and the power supply system 10, i.e., from the energy storage system 24. It is possible here to define a limiting value for the power delivery from the energy grid which is not exceeded in the normal case because the device adjusts the delivery to the system upon load detection. If the overall power of all systems is exceeded, software may be used to determine how this scenario may be addressed, or which peak load may be covered from the energy grid for possibly a few seconds. In this case the energy storage system 24 is always immediately recharged from the energy grid when “residual energy” is available (i.e., when the energy grid delivery is below the defined maximum). It is also possible externally to charge the energy storage system as in the operating modes described above. Another advantage of the LOADSHAPING/ON/OFF/HYBRID mode is that the loads are supplied without the energy grid (for example, shutting down a generator possibly present) until the quantity of energy in the energy storage system 24 has fallen below a settable value.

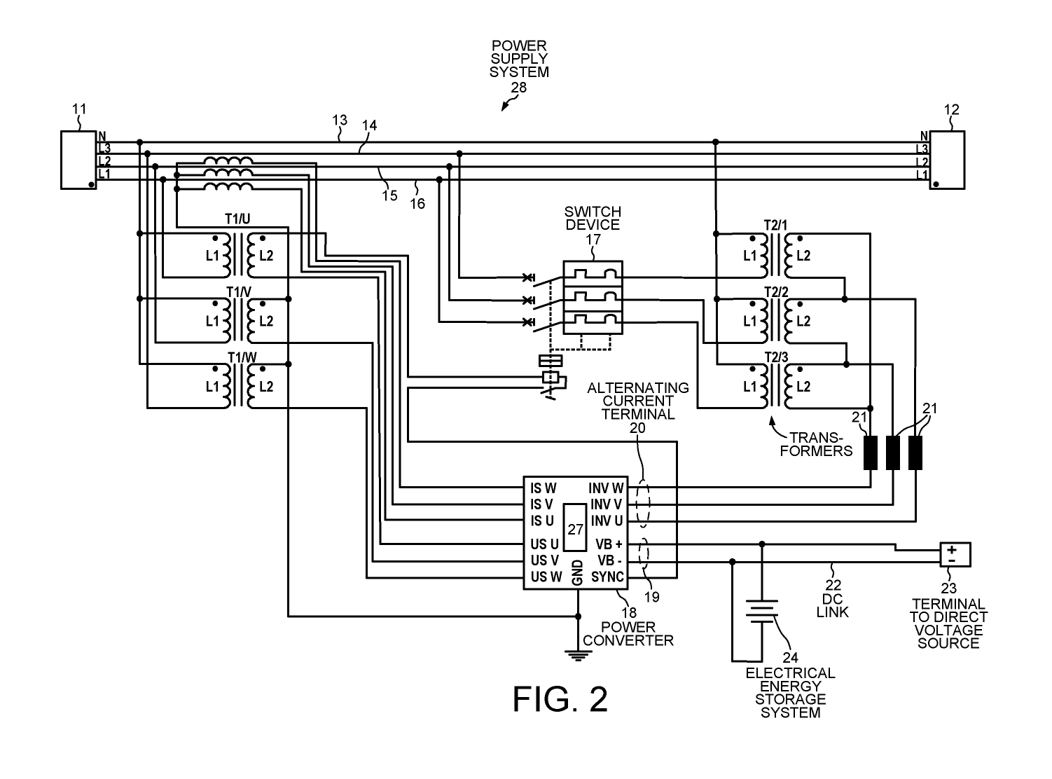

FIG. 2 illustrates a power supply system 28 that differs from the power supply system 10 of FIG. 1 in that the power supply lines 14, 15, 16 cannot be disconnected by the switch device 17. Thus, there is a constant power connection between the input terminal 11 and the output terminal 12. The switch device 17 is now arranged in such a way that the parallel coupling of the alternating current terminal 20 of the power converter 18 or of the terminal transformers associated therewith may thus be disconnected from the power supply lines 14, 15, 16.

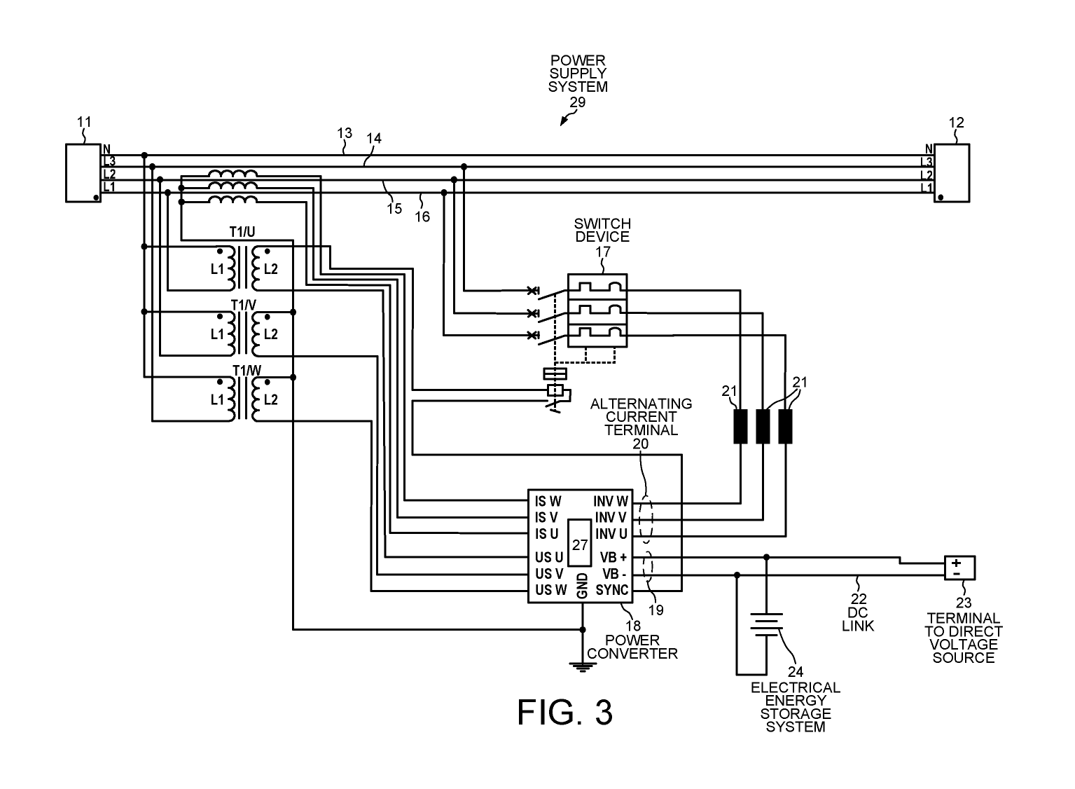

FIG. 3 illustrates a power supply system 29 that differs from the power supply system 28 of FIG. 2 in that the alternating current terminal 20 of the power converter 18 is connected to the phase conductors 14, 15, 16 in a delta connection so that the connection of terminal transformers in between may be dispensed with.

The power supply systems 28 and 29 of FIGS. 2 and 3 may be used for the following AC BUS HYBRID mode.

AC BUS HYBRID Mode:

In the AC BUS HYBRID mode, the power supply system is directly connected to the energy grid and allows assistance of the energy grid without switching intervention from the energy storage system 24. This mode allows a loadshaping mode in distribution networks and decentralized energy storage, for example in photovoltaic systems or wind turbines connected to the terminal 23. As soon as excess energy is available, it is deposited in the energy storage system 24 and is fed back to the network during the course of the day. Parallel connection of multiple AC BUS HYBRID systems is possible at any time without great effort in order to adapt the power to increasing demand. The power supply system controls the power delivery, automatically or by remote intervention. When a feed-side switch disconnector is used, the unit may be expanded to the AC OFF BUS HYBRID mode, and the local loads may be supplied from the energy storage system 24 in the event of a disturbance. It is then possible, for example, for small municipalities or businesses (which are supplied from a medium voltage station) to continue to receive power locally, largely without interruption, until the grid is restored. In special cases, feeding back into the medium voltage level, and thus supplying additional stations with a certain amount of switching effort, would also be possible. When AC BUS HYBRID systems are also in use at other medium voltage stations, the power is then automatically summed.

AC BUS HYBRID systems are suitable in particular in combination with high current systems because intervention in the high-current paths is not necessary, and instead the AC BUS HYBRID system is operated “only” in parallel thereto. It is only necessary to measure the voltage at an upstream disconnector to allow resynchronization in the AC OFF BUS HYBRID mode.

The predefined sequences of the control unit 27 of the power supply system are preferably implemented as software that interacts with the hardware components of the power converter 18 and optionally with the switch devices 17. In principle, the control and regulation may be carried out according to the following principle. In the power supply system, software is used to compute a rotating phasor grid map that fundamentally consists of frequency, voltage, and optionally current of the supply network. In the strictly OFF GRID mode, a definable fixed output frequency and a definable fixed output voltage are output, using software. The phase angles are likewise definable (US power grids: 2P/N 180° or 3P 120° D/2; EU and the rest of the world: 3P/120° 3W/4W). In the USV mode, the current is taken into account using the deadband method, and increasing the DC link voltage for charging is made possible by oscillating the throttles in the AC path. A phase-locked loop (PLL) allows phase-synchronous operation with rapid detectability of grid disturbances. All other operating modes are made possible by shifting the operating points and voltage levels. Active grid filtering, using existing hardware, is also possible.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

1.-19. (canceled)

20. A power supply system comprising:
an input terminal that receives electrical energy from an alternating current source;
an output terminal connected to a load;
a current measuring device that measures current values of the electrical energy received from the alternating current source;
a voltage measuring device that measures voltage values of the electrical energy received from the alternating current source;
a first phase conductor that connects the input terminal to the output terminal;
a neutral conductor that connects the input terminal to the output terminal;
a power converter that includes a direct current terminal and an alternating current terminal, wherein the alternating current terminal is coupled to the load, and wherein the power converter outputs an alternating voltage;
a chargeable electrical energy storage system;
a DC link that connects the direct current terminal to the chargeable electrical energy storage system; and
a control unit that controls the alternating voltage output by the power converter onto the alternating current terminal, wherein the alternating current terminal is connected to the phase conductor in parallel with the alternating current source, and wherein the control unit uses the current values and the voltage values to control the alternating voltage output by the power converter.

21. The power supply system of claim 20, wherein the power converter is a bidirectional power converter.

22. The power supply system of claim 20, wherein the input terminal receives power from a three-phase alternating current source, and wherein the input terminal is also connected to the output terminal by a second phase conductor and a third phase conductor.

23. The power supply system of claim 22, wherein the power converter converts a direct current into a three-phase alternating current and also converts a three-phase alternating current into a direct current.

24. The power supply system of claim 22, wherein the alternating current terminal of the power converter is a three-phase alternating current terminal.

25. The power supply system of claim 20, wherein the alternating current terminal is coupled to the first phase conductor through a matching transformer.

26. The power supply system of claim 25, wherein the matching transformer is coupled to the first phase conductor by a star connection, and wherein the matching transformer is coupled to the power converter by a delta connection.

27. The power supply system of claim 25, wherein the matching transformer is coupled through a throttle device to the alternating current terminal of the power converter.

28. The power supply system of claim 20, further comprising:
a switch device coupled between the first phase conductor and the alternating current terminal of the power converter, wherein the switch device opens and closes an electrical connection between the first phase conductor and the alternating current terminal.

29. The power supply system of claim 28, wherein the control unit controls the switch device.

30. The power supply system of claim 20, further comprising:
a switch device that selectively opens and closes an electrical connection between the input terminal and the output terminal.

31. The power supply system of claim 20, wherein the DC link has a terminal for connecting to a direct voltage source.

32. The power supply system of claim 31, wherein the direct voltage source is a photovoltaic system.

33. The power supply system of claim 20, wherein the control unit causes the power supply system to switch between operating in a first operating mode and operating in a second operating mode, wherein in the first operating mode the electrical energy from the alternating current source is supplied via the first phase conductor and the neutral conductor to both the load and the power converter, wherein the power converter operates as a rectifier and supplies direct current onto the DC link to charge the electrical energy storage system, wherein in the second operating mode the power converter supplies the load with alternating current after disconnecting an electrical connection between the input terminal and the output terminal, and wherein the power converter operates as an inverter and receives direct current via the DC link from the electrical energy storage system.

34. The power supply system of claim 33, wherein the control unit causes the power supply system to switch between operating in a third operating mode and operating in a fourth operating mode, wherein in the third operating mode the electrical energy received from the alternating current source is supplied to the load via the first phase conductor and the neutral conductor, wherein an external direct voltage source is coupled to the DC link and charges the electrical energy storage system, wherein in the fourth operating mode the external direct voltage source supplies the power converter with direct current via the DC link, and wherein the power converter operates as an inverter and outputs onto the first phase conductor an alternating current that is synchronized with the alternating current source.

35. The power supply system of claim 20, wherein the control unit causes the power supply system to operate in an operating mode in which an external direct voltage source is coupled to the DC link, charges the electrical energy storage system, and supplies direct current to the power converter, wherein the power converter operates as an inverter and outputs onto the first phase conductor an alternating current that is synchronized with the alternating current source, wherein the power converter supplies the load with alternating current when the electrical energy storage system is charged, and wherein the alternating current source supplies the load with alternating current when the electrical energy storage system is discharged.

36. A method for supplying power, comprising:
in a first operating mode, supplying electrical energy from an alternating current source through a first phase conductor both to a load and to a power converter of a power supply system, wherein the power converter operates as a rectifier, supplies direct current onto a DC link, and charges an electrical energy storage system of the power supply system; and
in a second operating mode, supplying alternating current from the power converter to the load after disconnecting an electrical connection between an input terminal and an output terminal of the power supply system, wherein the power converter operates as an inverter and receives direct current over the DC link from the electrical energy storage system.

37. The method for supplying power of claim 36, wherein in the first operating mode, the electrical energy is also supplied from the alternating current source to the load through a second phase conductor and a third phase conductor.

38. The method for supplying power of claim 36, further comprising:
in a third operating mode, supplying electrical energy from the alternating current source through the first phase conductor to the load, and charging the electrical energy storage system using an external direct voltage source that is connected to the DC link.

39. The method for supplying power of claim 36, further comprising:
in another operating mode, supplying the power converter with direct current over the DC link from an external direct voltage source, wherein the power converter operates as an inverter and supplies onto the first phase conductor alternating current that is synchronized with the alternating current source.

40. The method for supplying power of claim 36, further comprising:
in another operating mode, connecting an external direct voltage source to the DC link, supplying the power converter with direct current, and charging the electrical energy storage system, wherein the power converter operates as an inverter and supplies to the load via the first phase conductor alternating current that is synchronized with the alternating current source when the electrical energy storage system is charged, and wherein the alternating current source supplies the load with alternating current when the electrical energy storage system is discharged.
